(19) United States
(12) Patent Application Publication
(10) Pub. No.: US 2018/0093873 A1
(43) Pub. Date: Apr. 5, 2018

(54) METHOD OF FORMING A CONTAINER PACKAGING WITH AMBIENT FILL AND DIAPHRAGM INVERSION

(71) Applicant: SIDEL PARTICIPATIONS, Octeville-sur-mer (FR)

(72) Inventor: Vincent LE GUEN, Octeville-sur-mer (FR)

(21) Appl. No.: 15/563,799

(22) PCT Filed: Apr. 1, 2016
(86) PCT No.: PCT/EP2016/057249

§ 371 Date: Oct. 2, 2017

(30) Foreign Application Priority Data
Apr. 15, 2015 (EP) 15305568.6

(51) Int. Cl. B67C 3/26; B65D 1/06

(52) U.S. Cl. CPC B67C 3/2617; B67C 2003/2654; B65D 1/06

(57) ABSTRACT

Disclosed is a method of forming a packaging, the method including the steps of: providing an empty container including a sidewall, an opneck and a base, the container further including a invertible diaphragm in an outwardly-protruding position; a filling step of pouring, within the container through the neck, a product at a temperature lower than or equal to ambient temperature; a capping step of sealingly closing the filled container by way of a cap mounted onto the neck; an inversion step of displacing the diaphragm to an inwardly-protruding position, the inversion step being conducted within seconds after sealingly closing the container.

### FIELD OF THE INVENTION

The invention generally relates to the packaging of containers made of plastics, wherein containers are filled with contents at a temperature lower than or equal to ambient temperature, and then capped.

### BACKGROUND OF THE INVENTION

Containers are usually manufactured by blow molding, which generally comprises:
heating a blank (a term which designates either a raw injected preform or an intermediate container obtained by pre-blow molding a preform) made of a plastic material such as PET (polyethylene terephthalate) at a temperature above the glass transition temperature of the material (about 80° C. for PET),
inserting the such heated blank into a mold including a sidewall defining a counter print of the container,
injecting a gas (such as air) under pressure (equal to or more than 15 bars) into the blank.

The blowing may be supplemented by stretching the blank by means of a sliding rod (named “stretching rod”).

During blow molding or stretch blow molding, the material undergoes a dual molecular orientation (axial and radial, i.e. respectively parallel and perpendicular to the general axis of the container). This dual molecular orientation gives the container a certain structural rigidity.

However, recent years have witnessed a decrease in the quantity of material allowed for the manufacturing of containers. In other words, containers and, hence, preforms (or blanks) are always lighter, responding to requests for energy consumption—and pollution—reductions.

One well-known method of increasing the rigidity of a container is heat setting, which consists of increasing the cristallinity rate of the material by means of heat, and more precisely by heating the sidewall of the mold against which the material is applied at the end of blowing, see e.g. French patent No. FR 2 649 035 (Sidel Participations) or its American equivalent U.S. Pat. No. 5,145,632. However, due to its cost and its reduced production rates, heat setting is generally restricted to hot-fill containers, i.e. containers filled with a content at a temperature well above ambient temperature (generally above 80° C.).

For ambient fill applications (such as still water, flavored water, fruit juices), manufacturers usually resort to shape tricks to cheaply increase the mechanical strength of the containers. As an example, the container depicted in European and American patent applications No. EP 2 580 132 and US 2013/175236 (Sidel Participations) is provided with stiffeners which extend radially on the bottom of the container.

However, such stiffeners may prove insufficient in severe load conditions, e.g. if the container is located in the lower row of a pallet and/or if the allowed quantity of material further decreases.

### SUMMARY OF THE INVENTION

It is an object of the invention to increase the mechanical resistance of an ambient (or cold) fill container packaging.

It is another object of the invention to allow for further lightening of containers intended for ambient (or cold) fill.

It is therefore provided a method of forming a packaging, said method including the steps of:
providing an empty container comprising a sidewall, an open neck and a base, wherein said container includes an invertible diaphragm in an outwardly-protruding position;
a filling step of pouring, within the container through the neck, a product at a temperature lower than or equal to ambient temperature;
a capping step of sealingly closing the filled container by means of a cap mounted onto the neck;
an inversion step of displacing the diaphragm to an inwardly-protruding position, said inversion step being conducted within seconds after sealingly closing the container.

In various embodiments, taken either separately or in combination:
the base includes a high standing ring, and the diaphragm is centrally provided on the base;
the temperature of the poured product is lower than or equal to 40° C., and possibly lower than 20° C.;
the product is water;
the inversion step is conducted by means of a mechanical pusher;
the inversion step is initiated before completion of the capping step.

The above and other objects and advantages of the invention will become apparent from the detailed description of preferred embodiments, considered in conjunction with the accompanying drawings.

### BRIEF DESCRIPTION OF THE DRAWINGS

FIG. 1 is a cut view of an empty container provided with a high standing ring and a diaphragm shown in an outwardly-protruding position.

FIG. 2 is a cut view of the container of FIG. 1, during a filling step.

FIG. 3 is a cut view of the container of FIG. 1 and FIG. 2, after completion of the filling step and capping step.

FIG. 4 is a cut view of the container of FIG. 3, after completion of the inversion step.

### DETAILED DESCRIPTION

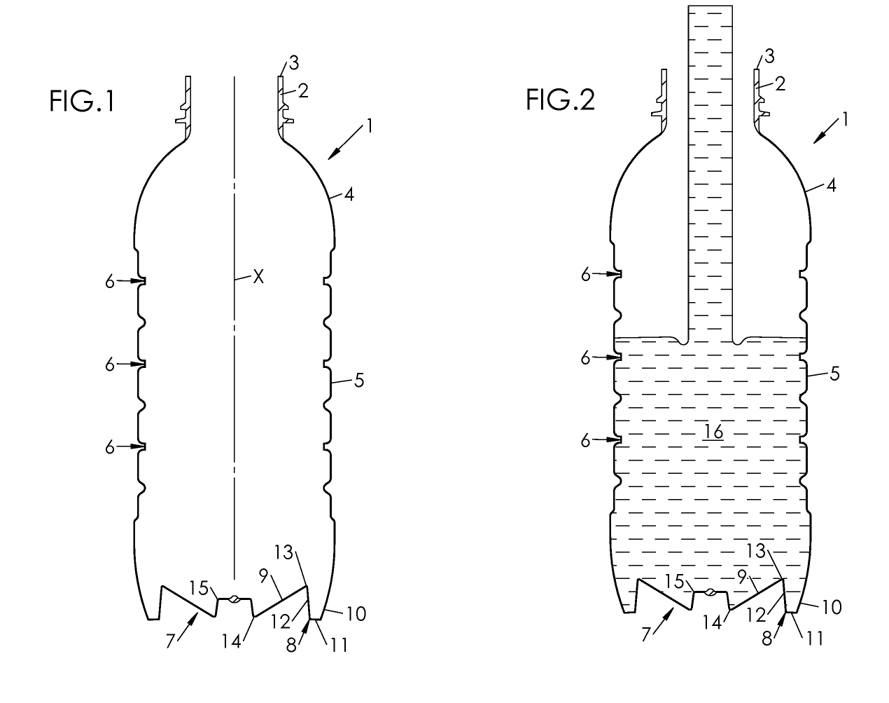

Shown on FIG. 1 is a container 1 manufactured by blow molding or stretch blow molding from a blank (e.g. a preform) made of plastic such as PET. As will be discussed hereinafter, the container 1 is suitable for being filled with a content at a temperature lower than or equal to ambient (or room) temperature. In one embodiment, the content is water (such as still water or flavored water). In another embodiment, the content is a fruit juice.

The container 1 includes an open cylindrical threaded upper portion or neck 2, which terminates, at an upper end thereof, by an opening or mouth 3 by which the container 1 is capable of being filled and subsequently emptied. Below the neck 2, the container 1 includes a shoulder 4 of increasing diameter in a direction opposite to the neck 2.

Below the shoulder 4, the container 1 has a sidewall 5, which is substantially cylindrical around a container main axis X. The sidewall 5 may, as depicted in FIG. 1, include annular stiffening ribs 6 designed to increase mechanical resistance of the sidewall 5 to stresses undergone by the container 1 during filling, capping and subsequent handling.

At a lower end of the sidewall 5, the container 1 has a base 7 (also called bottom), which closes the container 1 and allows it to be normally put on a planar surface (such as a table when used by a final customer, or such as an upper surface of a conveyor during automatic handling of the container 1).

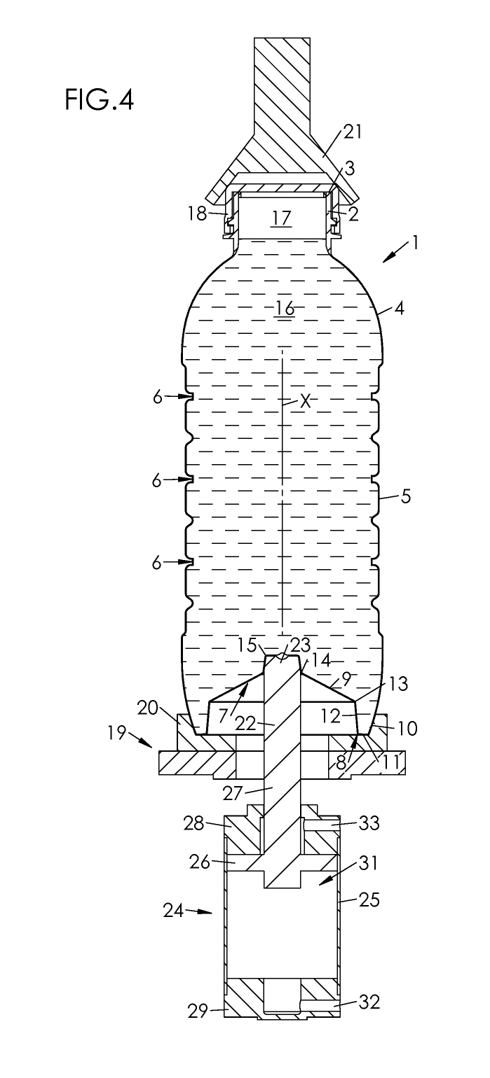

The container base 7 includes a standing ring 8, which is a high standing ring as it will be explained later, and a central invertible diaphragm 9, which has symmetry of revolution around the main axis X and is deformable with respect to the sidewall 5 between an outwardly-protruding (or lower) position shown on FIG. 1-FIG. 3, wherein the diaphragm 9 projects outwardly with respect to the container 1, and an inwardly-protruding (or upper) position, shown on FIG. 4, wherein the diaphragm 9 projects inwardly with respect to the container 1.

The container 1 is blow molded with the diaphragm 9 in its lower position. As will be explained in further details below, the diaphragm 9 is capable of being mechanically forced upwards (i.e. inwards with respect to the container 1) after the container 1 has been filled with a pourable product, in order to increase the overall rigidity of the filled container 1, for the benefits of mechanical performances of the container 1 during handling and storage, and also for the benefits of customer quality perception.

The standing ring 8 connects to the sidewall 5 of the container 1 at a lower end portion 10 thereof. The standing ring 8 has a support flange 11 adjacent and substantially perpendicular to the lower end portion 10 of the sidewall 5, and a cylindrical or frustoconical inner portion 12 which connects the support flange 11 to the diaphragm 9. The support flange 11 is also substantially perpendicular to the container main axis X.

In a preferred embodiment, the lower end portion 10 of the sidewall 5 has, when viewed in transversal section as shown on FIG. 1, the shape of an arch with a concavity turned inward with respect to the container 1, whereby the outer diameter of the support flange 11 is smaller than the overall diameter of the sidewall 5.

As depicted, the inner portion 12 preferably has the shape of a frustum of a cone and, when viewed in transversal section as shown on FIG. 1 and FIG. 2, inclines inwardly with respect to the container 1, with a draft angle.

The cone shape of the inner portion 12 provides a vault stiffening and locking function to the diaphragm 9 in its inverted position (shown in FIG. 4), whereby the restriction of diameter of the inner portion 12 at its junction with the diaphragm 9 prevents the latter to articulate back from its inverted position with respect to the inner portion 12. As a result, the risk of the diaphragm 9 inverting back from its inwardly-protruding position to its initial outwardly-protruding position under the pressure of the content is suppressed or, at least, lowered.

The surface of the diaphragm 9 is preferably smooth and has no corrugations. This may increase the force required for inverting the diaphragm 9 from its lower position to its upper position, but it however increases stability of the diaphragm 9 in the upper position and reduces the risk of inversion back to the lower position.

The inner portion 12 has an axial extension which is important with respect to the outer diameter of the support flange 11, hence the expression “high standing ring” to name the standing ring 8. More specifically, the axial extension (or height) of the inner portion 12 is greater than 1/10 of the outer diameter of the support flange 11, and preferably comprised between 1/10 and ⅕ of the outer diameter of the support flange 11.

In the blown configuration of the container 1 depicted on FIG. 1, the invertible diaphragm 9 extends outwards in a frusto-conical shape from an outer edge 13 where the diaphragm 9 connects to an upper end of the inner portion 12, to an inner edge 14 where the diaphragm 9 connects to a central upwardly protruding recess 15.

Also in the blown configuration of the container 1, the axial extension, or height, of the diaphragm 9, is such that the inner edge 14 of the diaphragm 9 extends slightly above a support plane defined at the junction between the support flange 11 and the lower end portion 10 of the sidewall 5. In other words, the height of the diaphragm 9 is slightly lower than the height of the standing ring 8.

After the container 1 has been blow molded, it undergoes, within a filling unit, a filling step of pouring a product 16 (such as a liquid, e.g. a beverage, for example water) through its neck 2 (and more precisely through its mouth 3). The product 16 is poured at a temperature, denoted T, lower than or equal to ambient temperature (denoted T₀), which corresponds to the average temperature which may be measured outside the container 1, not necessarily in the vicinity thereof. The filling step is depicted on FIG. 2. The filling step is conducted with the diaphragm 9 in the lower position.

When T<T₀, the filling is referred to as a cold filling.

When T=T₀ (or T≅T₀), the filling is referred to as an ambient filling.

If the ambient temperature T₀ is of about 40° C., then the temperature T of the product 16 is equal to or less than 40° C. This corresponds to ambient temperature in warm countries (such as tropical countries).

If the ambient temperature To is of about 20° C., then the temperature T of the product 16 is equal to or less than 20° C. (temperature T of the product may be even lower, such as in the case of spring water, which may be as fresh as 10° C.). Those examples are normal ambient temperature in western countries.

The container 1 is normally not fully filled, so there remains an empty volume (also called headspace) 17 above the product 16 within the neck 2. The volume of poured product 16 may vary from one container 1 to another. As a consequence, the headspace 17 may also vary from one container 1 to another, although the headspace 17 should always be substantially equal in volume to a reference headspace corresponding to the correct volume of dispensed product.

The filled container 1 then undergoes a capping step of sealingly closing the mouth 3 (and hence the container 1) by means of a cap 18 mounted onto the neck 2. In a preferred embodiment, neck 2 and cap 18 are both correspondingly threaded and the cap 18 is screwed onto the neck 2 to provide sealing closure of the container 1.

The container 1 also undergoes an inversion step of displacing the diaphragm 9 to its inwardly-protruding position.

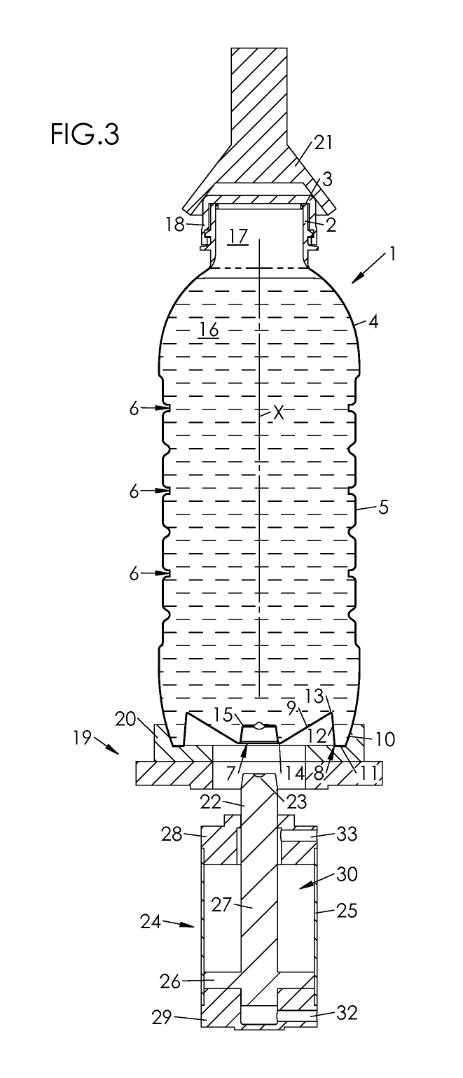

As depicted on FIG. 3 and FIG. 4, the inversion step may be conducted within a processing unit 19 comprising a container support ring 20 suitable for engaging the container base 7. More precisely, the support ring 20 forms a counter print of at least the support flange 11 and the lower end portion 10 of the container sidewall 5.

The processing unit 19 further includes a container retaining member 21 for rigidly retaining the container 1 in vertical position with its base located within the support ring 20 while the diaphragm 9 is being inverted.

In the depicted example, the retaining member 21 is provided with a conical head suitable for vertically coming into abutment with the cap 18 along the container axis X.

The processing unit 19 further includes a mechanical pusher 22 movable with respect to the support ring 20 and capable of coming into abutment with the container base 7 through the support ring 20 for inverting the diaphragm 9 from its outwardly-protruding position (FIG. 3) to its inwardly-protruding position (FIG. 4).

More precisely, the pusher 22 is slidingly displaceable along the axis X for coming into abutment within the central recess 15. In the depicted example, the pusher 22 has a tip 23 which is complementary in shape to the central recess 15, but the tip 23 may be of a simpler shape, such as a cylinder.

The processing unit 19 further includes an actuator 24 for slidingly moving the pusher 22 frontwards (i.e. upwards) towards the container base 7 through the support ring 20 in order to achieve inversion of the diaphragm 9, and backwards (i.e. downwards) thereafter, to be ready for the inversion cycle of another container.

More precisely, in the depicted example, it can be seen that the actuator 24 is a hydraulic or pneumatic cylinder, preferably of the two-way type.

The actuator 24 has a cylinder housing 25, a piston 26 and a rod 27 fixed to the piston 26, with the pusher 22 mounted onto the rod 27 or integral therewith.

In a known manner, the actuator 24 has a closure head 28 and a closure bottom 29 connected through the housing 25. The piston 26 defines within the housing 25 a front chamber 30 around the rod 27 and a back chamber 31 opposite to the rod 27, whereby the front chamber 30 is mainly defined between the piston 26 and the closure head 28 whereas the back chamber 31 is mainly defined between the piston 26 and the closure bottom 29.

The back chamber 31 is in fluidic connection, through a bottom fluid port 32 formed in the closure bottom 29, with a control valve linked to a source of fluid (such as air or oil) under pressure and to a vent. Likewise, the front chamber 30 is also in fluidic connection, through an upper fluid port 33 formed in the closure head 28, with a control valve linked to a source of fluid under pressure and to a vent. The back chamber 31 and front chamber 30 are alternately fluidly connected to the source of fluid and to the vent, so as to move the pusher 22 forth (or up) and back (or down) between a lower position in which the piston 26 is in the vicinity of the closure bottom 29 (FIG. 3), and an upper position in which the piston 26 is in the vicinity of the closure head 28 (FIG. 4).

Inversion of the diaphragm 9 is conducted as described hereinafter.

Starting from the lower position of the piston 26, the back chamber 31 is connected to the source of fluid whereas the front chamber 30 is connected to the vent, so that the piston 26, together with the whole mechanical pusher 22, begins to move forward (or up), away from its lower position. The pusher 22 moves forward in a linear manner with respect to time as long as it encounters no resistance.

About one tenth of a second to few tenths of a second after the back chamber 31 has been connected to the source of fluid, the pusher 22 comes in contact with the container base 7, and more precisely with the central recess 15, and begins to push the same inwards with respect to the container 1. As the pusher 22 continues to move upwards to its upper position, the diaphragm 9 is inverted to its inwardly-protruding position (FIG. 3).

During inversion of the diaphragm 9, the product 16, which is virtually incompressible, is displaced upwardly, whereby the gas (generally air) enclosed in the headspace 17 is compressed by a volume substantially equal to the volume (so-called extraction volume) swept by the diaphragm 9 during its inversion, between its outwardly-protruding and outwardly-protruding positions.

After the pusher 22 has reached its upper position, it is preferably held in position for a period of time of several tenths of seconds to about one second or few seconds to ensure stabilization (and dampen vibrations) of the diaphragm 9 in its inwardly-protruding position and prevent its re-inversion back to its outwardly-protruding position.

The pusher 22 is then moved back to its lower position which it holds until the next cycle is initiated with another container 1. To do so, the front chamber 30 is connected to the source of fluid whereas the back chamber 31 is connected to the vent, so that the piston 26, together with the whole mechanical pusher 22, moves backwards to the lower position.

The inversion step is conducted within seconds after sealingly closing the container 1. The expression “sealingly closing” does not necessarily mean that the cap 18 is completely screwed onto the neck 2. It rather means that the cap 18 provides sealing closure of the container 1, which may be achieved after only few degrees of rotation of the cap 18 onto the neck 2.

The inversion step may therefore be initiated before completion of the capping step, provided that sealing closure of the container 1 is achieved. As the cap 18 is screwed onto the neck 2, the volume of headspace 17 decreases, and air pressure inside it therefore increases.

As the effort needed to invert the diaphragm 9 depends upon the pressure inside the headspace 17, the sooner the inversion step is initiated, the smaller the effort required to initiate inversion of the diaphragm 9 is. As the capping step generally lasts about one second, the inversion step may be initiated less than one second (e.g. few tenths of seconds) after initiation of the capping step, which may be achieved during inversion of the diaphragm 9.

Of course, the inversion step may also be initiated after completion of the capping step but the effort required to initiate inversion of the diaphragm 9 would then be greater. In that case, the inversion may be conducted immediately after completion of the capping step, i.e. less than one second (e.g. few tenths of seconds) after the cap 18 is completely screwed onto the neck 2.

As the content is at ambient (or cold) temperature, the filled container 1 undergoes no volume decrease after filling and capping. Therefore, inversion of the diaphragm 9 does not compensate any volume loss (vacuum) inside the container 1. In other words, the whole extraction volume is used to add extra pressure inside the filled container 1, and more precisely in the headspace 17 (as the product 16 is incompressible or deemed so). This extra pressure results in great rigidity of the sidewall 5, whereby the container 1 may undergo high compression efforts when stacked or palletized.

Presence of the high standing ring 8 has several advantages.

Firstly, as the diaphragm 9 extends above the support flange 11 in the outwardly-protruding position, the container 1 may be transported with ordinary conveyors, i.e. the container 1 may rest onto a flat surface of a conveyor by its support flange 11.

Secondly, as already stated, the conical shape (or draft angle) of the inner portion 12 provides a locking function to the diaphragm 9 in its inwardly-protruding position. The sharp outer edge 13 also helps preventing the diaphragm 9 to articulate back to its outwardly-protruding position.

In addition, smoothness and symmetry of revolution (around axis X) of the diaphragm 9 helps the same to maintain its inwardly-protruding position.

In other embodiments, the invertible diaphragm 9 may be provided on the container in another area than the base 7. For example, in one embodiment, the diaphragm is provided on the container sidewall 5. In such a case, the pusher used to invert the diaphragm moves radially with respect to the container instead of moving axially.

1. Method of forming a packaging, said method including the steps of:
providing an empty container (1) comprising a sidewall (5), an open neck (2) and a base (7);
a filling step of pouring, within the container (1) through the neck (2), a product (16) at a temperature lower than or equal to ambient temperature;
a capping step of sealingly closing the filled container (1) by means of a cap (18) mounted onto the neck (2);
wherein:
the container (1) includes an invertible diaphragm (9), said diaphragm (9) being in an outwardly-protruding position;
the method further includes an inversion step of displacing the diaphragm (9) to an inwardly-protruding position, said inversion step being conducted after sealingly closing the container (1), the inversion step being initiated before completion of the capping step.

2. Method according to claim 1, wherein the base (7) of the container (1) includes a high standing ring (8) and the invertible diaphragm (9) is centrally provided on the base (7).

3. Method according to claim 1, wherein the temperature of the poured product is lower than or equal to 40° C.

4. Method according to claim 3, wherein the temperature of the poured product (16) is lower than or equal to 20° C.

5. Method according to claim 1, wherein the product (16) is water.

6. Method according to claim 1, wherein the inversion step is conducted by means of a mechanical pusher (22).

7. Method according to claim 2, wherein the temperature of the poured product is lower than or equal to 40° C.

8. Method according to claim 2, wherein the product (16) is water.

9. Method according to claim 3, wherein the product (16) is water.

10. Method according to claim 4, wherein the product (16) is water.

11. Method according to claim 5, wherein the product (16) is water.

12. Method according to claim 2, wherein the inversion step is conducted by means of a mechanical pusher (22).

13. Method according to claim 3, wherein the inversion step is conducted by means of a mechanical pusher (22).

14. Method according to claim 4, wherein the inversion step is conducted by means of a mechanical pusher (22).

15. Method according to claim 5, wherein the inversion step is conducted by means of a mechanical pusher (22).

16. Method according to claim 7, wherein the inversion step is conducted by means of a mechanical pusher (22).

17. Method according to claim 8, wherein the inversion step is conducted by means of a mechanical pusher (22).

18. Method according to claim 9, wherein the inversion step is conducted by means of a mechanical pusher (22).

19. Method according to claim 10, wherein the inversion step is conducted by means of a mechanical pusher (22).

20. Method according to claim 11, wherein the inversion step is conducted by means of a mechanical pusher (22).
